(19) United States
(12) Patent Application Publication
(10) Pub. No.: US 2014/0065909 A1
(43) Pub. Date: Mar. 6, 2014

(54) CARBON COMPOSITE MATERIAL

(71) Applicant: AGENCY FOR DEFENSE DEVELOPMENT, Daejeon (KR)

(72) Inventors: Jae-Yeol LEE, Daejeon (KR); Jong-Kyoo PARK, Daejeon (KR); Seung-Su BAEK, Daejeon (KR)

(73) Assignee: AGENCY FOR DEFENSE DEVELOPMENT, Daejeon (KR)

(21) Appl. No.: 13/827,518

(22) Filed: Mar. 14, 2013

(30) Foreign Application Priority Data
Sep. 3, 2012 (KR) 10-2012-0097146

(51) Int. Cl. B32B 5/28; C08K 3/04

(52) U.S. Cl. CPC B32B 5/28; C08K 3/04
USPC 442/136; 106/286.8; 524/611

(57) ABSTRACT

A carbon composite material which comprises Lyocell-based carbon fiber and a carbon matrix is provided. The carbon composite material has excellent physical properties, including low thermal conductivity, excellent interfacial adhesion and excellent strength, compared to carbon composite materials prepared using conventional polyacrylonitrile-based carbon fiber, pitch-based carbon fiber or the like. In addition, the carbon composite material is environmentally friendly and has low production costs compared to carbon composite materials comprising conventional rayon-based carbon fiber produced using a highly toxic carbon disulfide solvent.

### CROSS-REFERENCE TO RELATED APPLICATION

This application claims priority to Korean Patent Application No. KR 10-2012-0097146. filed on Sep. 3, 2012, which is incorporated herein by reference in its entirety.

### BACKGROUND OF THE INVENTION

1. Field of the Invention

Exemplary embodiments of the present invention relate to a carbon composite material comprising Lyocell-based carbon fiber.

2. Description of Related Art

Carbon composite materials comprise carbon fiber reinforcement and carbon matrix, which have both good heat resistance and good mechanical properties.

The reinforcement required for the preparation of carbon composite materials is prepared by various methods.

Carbon fiber reinforcements are classified, according to the fiber arrangement, into random fiber reinforcement in which short carbon fibers are randomly distributed, one-dimensional (1D) fiber reinforcement in which all carbon fibers are arranged in parallel in the same direction, two-dimensional (2D) fiber reinforcement in which carbon fibers are arranged in a planar configuration, like fabric, and three-dimensional (3D) fiber reinforcement in which all carbon fibers are reinforced in three dimensional directions.

Carbon fibers which are used in the preparation of the carbon composite materials are mainly produced by carbonizing polyacrylonitrile fibers at high temperature, and in some cases, are produced from rayon fibers or pitch fibers.

Carbon composite materials comprising conventional carbon fiber have excellent heat resistance and fire resistance etc., and thus can be widely used in various fields, whereas conventional polyacrylonitrile-based carbon fibers have high thermal conductivity, and conventional rayon-based carbon fibers are produced using a highly toxic carbon disulfide solvent which can cause environmental pollution.

### Prior Art Documents

(Patent Documents)

Patent Document 1: Korean Patent Registration No. 10-1138291

### SUMMARY OF THE INVENTION

An embodiment of the present invention is to provide a carbon composite material comprising Lyocell-based carbon fiber, which has low thermal conductivity, excellent interfacial adhesion and low production costs and is environmentally friendly, compared to carbon composite materials prepared using conventional carbon fibers.

In accordance with an embodiment of the present invention, a carbon composite material includes Lyocell-based carbon fiber and a carbon matrix.

### BRIEF DESCRIPTION OF DRAWINGS

FIG. 1 is a schematic view of fiber rods made of carbon fiber.

FIG. 2 is a schematic view showing the cross-section of carbon fiber fabric.

FIG. 3 shows various methods for arranging carbon fiber rods.

### DESCRIPTION OF SPECIFIC EMBODIMENTS

Exemplary embodiments of the present invention will be described below.

The present invention provides a carbon composite material comprising Lyocell-based carbon fiber and a carbon matrix.

The Lyocell-based carbon fiber is preferably surrounded by a carbon matrix. Specifically, the Lyocell-based carbon fiber serves as reinforcement for the carbon composite material, and the carbon matrix serves as a matrix that surrounds the Lyocell-based carbon fiber, thereby improving the physical properties of the carbon composite material.

The Lyocell-based carbon fiber preferably comprises carbonized Lyocell fiber. Specifically, the Lyocell-based carbon fiber is preferably produced by carbon fiber production processes including a pretreatment process, a stabilization process, a carbonization process and a graphitization process. Lyocell fibers are produced by newly developed processes which do not use a component, which causes environment pollution and is harmful to the human body. These fibers are dry or wet spun fibers produced using cellulose-based natural pulp and the solvent N-methylmorpholine-N-oxide (NMMO), which dissolves pulp, as main materials. The raw material for producing the Lyocell fibers is cellulose extracted from wood pulp, is a completely biodegradable polymer and is recyclable and environmentally friendly. In addition, these fibers can be produced using a process which does not discharge pollutants, unlike conventional rayon fibers.

The Lyocell-based carbon fiber is preferably produced by heat-treating Lyocell fiber at a temperature ranging from 100 to 2800° C. Specifically, the stabilization process is carried out in two steps. Preferably, the first step of the stabilization process is carried out at a temperature ranging from 100 to 250° C. for 10-30 hours, and the second step is carried out at a temperature ranging from 300 to 500° C. for 10-100 hours. If the stabilization process is carried out in the above-described temperature range, the resulting fiber is highly stable without thermal decomposition.

The carbonization process is preferably carried out by heat treatment at a temperature ranging from 900 to 1700° C. for 10-30 hours. If the carbonization process is carried out in the above temperature range, high carbonization efficiency is ensured.

The graphitization process is preferably carried out by heating the fiber to a graphitization temperature between 2000 and 2800° C. and maintaining the fiber at a temperature between 2000 and 2800° C. for 10 hours or shorter. If the graphitization process is carried in the above temperature range, the degree of graphitization of the fiber can be increased.

The Lyocell-based carbon fiber preferably has a carbon content of 50% or more, and more preferably 80% or more. If the carbon content is within the above range, the carbon composite material is lightweight and has excellent strength.

The Lyocell-based carbon fiber preferably has either a long fiber structure consisting of filament yarns or a spun yam structure made by twisting short fibers, but is not limited thereto.

The Lyocell-based fiber preferably has the form of woven fabric, nonwoven fabric, knitted fabric, multiaxial warp knitted fabric, unidirectional fabric, web or chopped fiber, but is not limited thereto.

The Lyocell-based carbon fiber is produced by carbonizing Lyocell fiber and is preferably in the form of a fiber rod obtained by combining the Lyocell fiber with binder resin. In the case of a carbon composite material comprising the rod-shaped Lyocell-based carbon fiber, a mechanical load applied to the carbon composite material can be immediately taken up by the Lyocell-based carbon fiber, and thus is very effectively transferred to the Lyocell-based carbon fiber. This suggests that the carbon composite material comprising the rod-shaped Lyocell-based carbon fiber has significantly improved strength and modulus compared to a carbon composite material comprising unshaped carbon fiber fabric or carbon fiber.

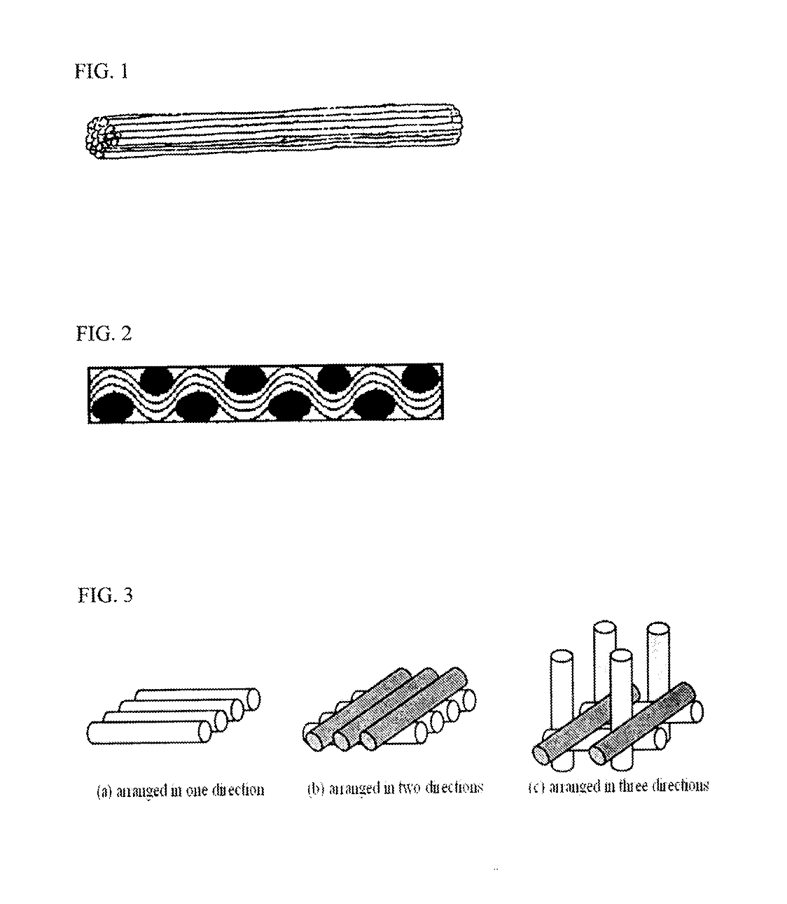

FIG. 1 is a schematic view of fiber rods made of carbon fiber, and FIG. 2 is a schematic view showing the cross-section of carbon fiber fabric.

As can be seen in FIG. 1, the rod-shaped carbon fiber has excellent straightness, whereas the carbon fiber shown in FIG. 2 has poor straightness due to many crimps caused by the intersection between the warp and the weft.

Specifically, the rod-shaped carbon fiber having excellent straightness functions to immediately take up load, and thus a composite material comprising the same has high strength and modulus, whereas a carbon fiber haying poor straightness as shown in FIG. 2 does not exhibit sufficient strength until the fiber is pulled taut in the direction of application of load, that is, the crimps of the fiber completely stretch. In addition, the carbon fiber having poor straightness also has a disadvantage of low modulus, because it can be easily deformed until the crimps completely stretch. Such carbon fiber rods can he arranged in various directions as shown in FIG. 3 to produce carbon composite materials having various structures. The carbon composite materials produced as described above can exhibit a very high strength and modulus in the direction in which the fiber rods are arranged.

As described above, the carbon composite materials of the present invention comprises the rod-shaped Lyocell-based carbon fiber comprising the binder resin, and thus can exhibit a very high strength and modulus.

The binder resin is preferably polyvinyl alcohol resin, epoxy resin or phenolic resin, but is not limited thereto.

The carbon composite material is preferably prepared by combining the Lyocell-based carbon fiber with the carbon matrix using a resin impregnation and carbonization process, a chemical vapor infiltration process or a pitch impregnation and carbonization process. Specifically, processes for impregnating the Lyocell-based carbon fiber with the carbon matrix include, but are not limited to: a resin impregnation and carbonization process in which the carbon fiber is impregnated with the polymer resin and carbonized at high temperature; a chemical vapor infiltration process in which a carbon component obtained by thermally decomposing hydrocarbon gas is deposited on the carbon fiber; and a pitch impregnation and carbonization process in which the carbon fiber is impregnated with pitch generated from coal or petroleum.

In the resin impregnation and carbonization process, the carbon composite material is preferably prepared using phenolic resin, furan resin or polyarylacetylene resin, but is not limited thereto. The use of said phenolic resin, furan resin or polyarylacetylene resin has art advantage in that the amount of carbon remaining after high-temperature carbonization is large so that the carbon fiber can be effectively impregnated with the carbon matrix.

In the chemical vapor infiltration process, the carbon composite material is preferably prepared using a hydrocarbon having 1 to 7 carbon atoms per molecule, but is not limited thereto. If the number of carbon atoms in the hydrocarbon is within the above range, the hydrocarbon vaporized by heating will be easily infiltrated into the carbon fiber, but if the number of carbon atoms is 8 or more, the hydrocarbon vaporized by heating will not be easily infiltrated into the carbon fiber.

In the pitch impregnation and carbonization process, the carbon composite material is preferably prepared using coal-based pitch or petroleum-based pitch, but is not limited thereto. The use of the coal-based pitch or petroleum-based pitch has an advantage in that the amount of carbon remaining after high-temperature carbonization is large so that the carbon fiber can be effectively impregnated with the carbon matrix. In addition, the coal-based pitch or petroleum-based pitch is cost-effective.

Hereinafter, the present invention will he described with reference to examples, but the scope of the present invention is not limited to these examples.

### EXAMPLE 1

Lyocell fiber was woven into twill fabric using a rapier loom and then washed by immersion in 99.8% pure acetone for about 2 hours. The washed fabric was immersed in a solution of 5 wt % of RTV silicone (silicone-based polymer) in perchloroethylene at about 25° C. for about 30 minutes, and then immersed in an aqueous solution of 15 wt % of ammonium chloride (flame-retardant salt) for about 30 minutes, followed by drying at a temperature of about 80° C.

The pretreated Lyocell fabric was heated in a heat-treatment furnace to a temperature of about 200° C. at a rate of 30° C./hr, and then heated to 300° C. at a rate of 2° C./hr, thereby stabilizing the fabric. Then, the stabilized fabric was heated to 1700° C. at a rate of 50° C./hr and carbonized for 10 hours. The carbonized fabric was heated to 2000° C. at a rate of 100° C./hr and graphitized for 1 hour, thereby manufacturing Lyocell-based carbon fiber fabric which has a carbon content of 90% or more and an areal density of 350 g/m² and consists of long fiber.

A 70% solution of phenolic resin in a methanol solvent was prepared. The Lyocell-based carbon fiber fabrics were immersed in the phenolic resin solution, stacked on top of each other, heated to 150 in an autoclave, and pressed at 200 psi for 3 hours, thereby preparing a flat-type composite material. Then, the flat-type composite material was carbonized at 1500° C. Then, the carbonized flat-type composite material was immersed in phenolic resin, after which the process of heating to 150° C. and pressing at 200 psi for 3 hours and the process of carbonization at 1500° C. were repeated additional three times, thereby preparing a carbon composite material.

### COMPARATIVE EXAMPLE 1

A carbon composite material was prepared in the same manner as Example 1, except that polyacrylonitrile-based carbon fiber was used instead of the Lyocell-based carbon fiber.

### COMPARATIVE EXAMPLE 2

A carbon composite material was prepared in the same manner as Example 1, except that non-carbonized Lyocell fiber was used instead of the Lyocell-based carbon fiber.

### Test Example 1

The physical properties of the carbon composite materials prepared in Example 1 and Comparative Example 1 were tested, and the results of the test are shown in Table 1 below.

TABLE 1

| | | Comparative |
|---|---|---|
| | Example 1 | Example 1 |
| Thermal conductivity | 41 | 53 |
| (W/mK) | | |
| Shear strength (MPa) | 16 | 13 |

As can be seen in Table 1 above, the carbon composite material prepared in Example 1 according to the present invention showed low thermal conductivity and high shear strength compared to the carbon composite material prepared using conventional polyacrylonitrile-based carbon fiber in Comparative Example 1. Thus, the carbon composite material of Example I has excellent physical properties.

### Test Example 2

The physical properties of the carbon composite materials prepared in Example 1 and Comparative Example 2 were tested, and the results of the test are shown in Table 2 below.

TABLE 2

| | | Comparative |
|---|---|---|
| | Example 1 | Example 2 |
| Heat resistance (° C.) | 1000 or higher | 330 |

As can he seen in Table 2 above, the carbon composite material prepared in Example 1 according to the present invention showed high heat resistance compared to the carbon composite material prepared using non-carbonized Lyocell fiber in Comparative Example 2. Thus, the carbon composite material of Example 1 has excellent physical properties.

As described above, the carbon composite material comprising Lyocell-based carbon fiber according to the present invention has excellent physical properties, including low thermal conductivity, excellent interfacial adhesion and excellent strength, compared to carbon composite materials prepared using conventional polyacrylonitrile-based carbon fiber, pitch-based carbon fiber or the like.

In addition, the carbon composite material of the present invention comprises Lyocell fiber produced using an N-methylmorpholine-N-oxide (NMMO) solvent, which is harmless to the human body and the environment and is recyclable. Thus, the carbon composite material of the present invention is environmentally friendly and has low production costs compared to carbon composite materials comprising conventional rayon-based carbon fiber produced using a highly toxic carbon disulfide solvent.

What is claimed is:

1. A carbon composite material comprising Lyocell-based carbon fiber and a carbon matrix.

2. The carbon composite material of claim 1, wherein the Lyocell-based carbon fiber comprises carbonized Lyocell fiber.

3. The carbon composite material of claim 1, wherein the Lyocell-based carbon fiber is surrounded by the carbon matrix.

4. The carbon composite material of claim 1, wherein the Lyocell-based carbon fiber is produced by heat-treating Lyocell fiber at a temperature ranging from 100 to 2800° C.

5. The carbon composite material of claim 1, wherein the Lyocell-based carbon fiber has either a long fiber structure consisting of filament yarns or a spun yarn structure made by twisting short fibers.

6. The carbon composite material of claim 1, wherein the Lyocell-based carbon fiber has a form of woven fabric, nonwoven fabric, knitted fabric, multiaxial warp knitted fabric, unidirectional fabric, web or chopped fiber.

7. The carbon composite material of claim 1, wherein the Lyocell-based carbon fiber is in a form of a fiber rod comprising binder resin.

8. The carbon composite material of claim 7, wherein the binder resin is polyvinyl alcohol resin, epoxy resin or phenolic resin.

9. The carbon composite material of claim 1, wherein the carbon composite material is prepared by combining the Lyocell-based carbon fiber with the carbon matrix using a resin impregnation and carbonization process, a chemical vapor infiltration process or a pitch impregnation and carbonization process.

10. The carbon composite material of claim 9, wherein the resin impregnation and carbonization process is carried out using phenolic resin, furan resin or polyarylacetylene resin.

11. The carbon composite material of claim 9, wherein the chemical vapor infiltration process is carried out using a hydrocarbon having 1 to 7 carbon atoms per molecule.

12. The carbon composite material of claim 9, wherein the pitch impregnation and carbonization process is carried out using coal-based pitch or petroleum-based pitch.
